(19) United States
(12) Patent Application Publication
(10) Pub. No.: US 2021/0073851 A1
(43) Pub. Date: Mar. 11, 2021

(54) METHOD FOR ENABLING ADVERTISING OR PROMOTIONAL INFORMATION PRESENTED DURING CONTENT BEING PLAYED TO BE SAVED IN A DIGITAL WALLET FOR LATER ACCESS

(71) Applicant: ACTV8, Inc., Beverly HIlls, CA (US)

(72) Inventor: Brian Shuster, Beverly Hills, CA (US)

(21) Appl. No.: 17/102,161

(22) Filed: Nov. 23, 2020

Related U.S. Application Data
(63) Continuation-in-part of application No. 16/673,905, filed on Nov. 4, 2019.
(60) Provisional application No. 62/768,581, filed on Nov. 16, 2018.

(51) Int. Cl. G06Q 30/02; G06Q 20/36

(52) U.S. Cl. CPC G06Q 30/0239; G06Q 20/363; G06Q 30/0277; G06Q 30/0258; G06Q 30/0236

(57) ABSTRACT

A method for enabling advertising or promotional information presented during content being played to be saved for later access. The method includes receiving a video or audio link from an external source for playing a video or audio on a display device. The display device includes a display screen, processor and communications components to enable the display device to communicate via a media network. During the playing, the method includes receiving an offer from a second external source, pausing the playing and displaying the offer on the display device. While displaying the offer, an option to save the offer is provided after which the content continues playing after the offer is saved. The offer is saved to a wallet app running on the display device. If an auto-save option is enabled, the offer is auto-saved to a user's digital wallet with no further action by the user.

### BACKGROUND OF THE INVENTION

The invention is directed to improvements concerning how offers (static or streaming) are provided to consumers on interactive streaming devices by enabling the delivery of offers during the streaming of audio and video content. The offers can be saved to a digital wallet on the digital device so that the user can continue to have the audio or video content streamed and be able to access the saved offer at a later time by accessing the digital wallet whenever desired.

FIG. 1 represents a mobile device or other display device 11 with advertising 13 presented while an audio or video content 15 is being played. It shows a ‘Learn More’ button 17 which, when selected, links to information from an external website which is retrieved and displayed 19 on the mobile device. In this manner, current online ad or streaming ads provide an option for a user to click through to ‘Learn More’ or purchase a product/service from a link embedded in the video content. The current market solution takes a user from the audio or video content 15 being played and typically opens a new tab or window for the user to then browse and choose how to proceed, typically to obtain more information or to make a purchase. The result is distracting for users as it takes them completely out of the audio or video content that they had been listening to or watching. It also creates an issue for the streaming platform, as the user now leaves the streaming platform to see the content on the advertiser's link if interested. Even if interested in the ad, the user may opt to ignore the ad and continue with the audio or video content being played.

### SUMMARY OF THE INVENTION

Currently, when a user is watching a video or listening to audio content via a browser or via an app on a mobile device, when an ad plays there is not much action for the user to do other than skip the ad, if such option is available, tap to open a URL provided by the ad, or wait until the ad is over. This invention is directed to a new digital ad concept that allows the user to receive relevant products/offers/coupons/digital currency or anything else of value or possible interest to a user (hereinafter “offer”) based on the ad being served and the user watching the ad and saving the offer directly to a user's digital wallet app, e.g., Apple® Wallet, Google® Pay or other third-party wallet app.

More specifically, the invention allows for automatically delivering advertising information during playback of a video or audio commercial on a mobile device or other display device by, in an embodiment, displaying user engagement prompts, for example through tapping a button, that prompts an offer currency to be saved into a digital wallet. This allows the user to continue watching the video or listening to the audio content with minimal delay and distraction while maintaining the ability to revisit the offer by accessing the digital wallet at any later time. In an embodiment, the user can opt in an auto save feature so that all offers which are presented are saved to the digital wallet.

As an example, when a user is on a mobile device watching video content via a website or app and when available, an advertising offer is displayed. The user saves the offer to a digital wallet and continues to watch the video content, knowing that the offer can be accessed at any time.

The invention enables video or audio content while being played to trigger an offer and with one click, or automatically, the user can save the offer to a digital wallet, which, other than minimally, does not distract the user from the video or audio playing, which then continues to play. Unlike the prior art, the user is not taken to the advertiser's web platform and continues to stay within the audio or video streaming environment.

### BRIEF DESCRIPTION OF THE DRAWINGS

FIG. 1 is a diagram showing a mobile device or other display with a prior art ad on top of a video.

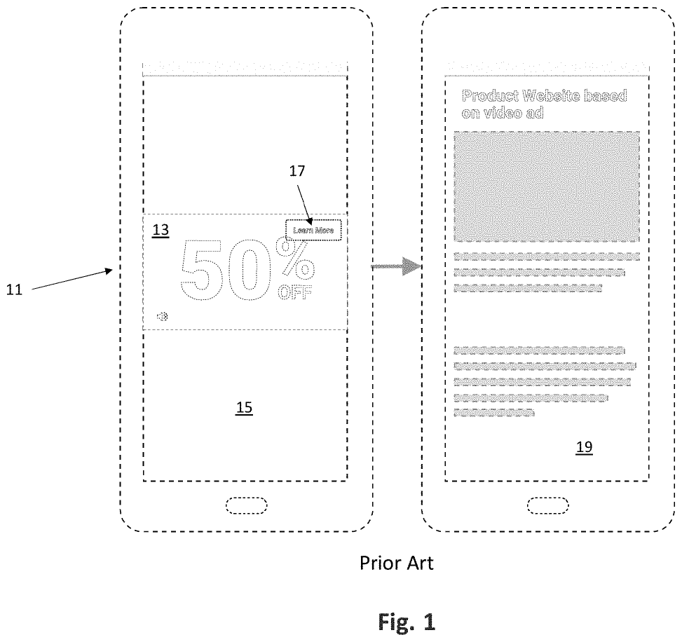

FIG. 2 is a diagram showing a mobile device or other display with an auto-save button provided by the invention.

FIG. 3 is a diagram showing the high-level process flow between the Media Player and the Backend Server before an end-user auto-save opt-in provided by the invention.

FIG. 4 is a high-level process flow between the Media Player and the Backend Server after an end-user auto-save opt-in provided by the invention.

FIG. 5 is a detailed block diagram of the process flow between system components involved in the delivery of contextual offers using the “Auto-Save” feature.

FIG. 6 is a detailed block diagram of the process flow between system components involved in the delivery of contextual offers using the “Auto-Save” feature.

### DETAILED DESCRIPTION OF THE INVENTION

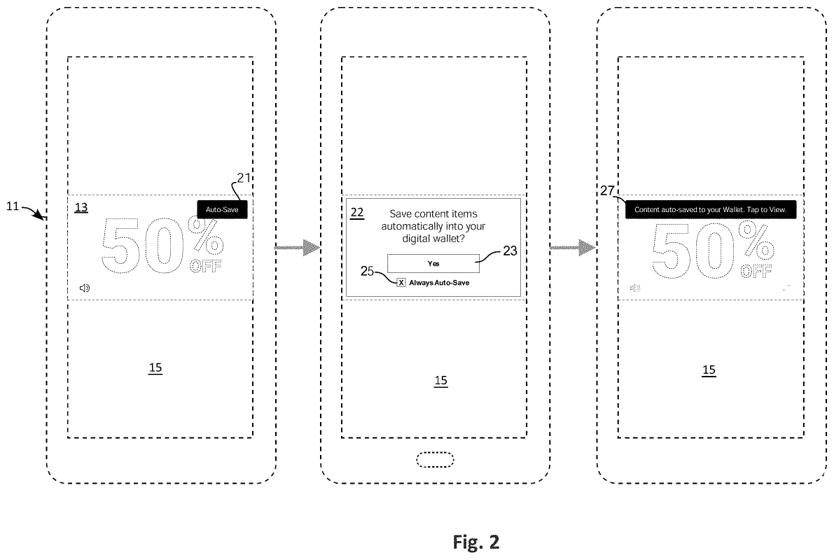

FIG. 2 represents a screen of a mobile device displaying a video being played with the invented auto-save functionality allowing users to save the offer to a digital wallet for later use, skip the rest of the ad and continue viewing the video being played.

As shown in FIG. 2, a media player of any kind running on a mobile or other display device 11 is playing a video 15, which, when paused, presents an ad or offer 13 as in the prior art. The mobile/display device such as a mobile phone or computer tablet includes communications components to enable the device to communicate with other devices or servers over a network such as the Internet or a phone network. The display device also includes API clients which are application program interfaces which enable programs running on the display device to operate with software running on external devices or other programs running on the display device as is well known in the art. Such communications components and communications capabilities and APIs are well known in the art, and therefore, will not be further described herein. Similarly, the display device as well as the various servers described herein include a memory and/or other storage elements, processors, APIs, communications components and the like, all of which are well known in the art. However, the invention includes an auto-save button 21. The wording inside the button is dynamic and can be customized as desired (e.g. ‘Auto Save’). Although not required, when button 21 is displayed, the ad screen area is changed to a neutral background so that the ad content is clear. The ad can be in the nature of an offer related to the video content or can be completely unrelated. Button 21 is an active button which provides the ability to automatically deliver an offer to a digital wallet app. Upon tapping on the “Auto-Save” button 21, the end-user is presented with a preference panel 22 with the option to opt-in for the auto saving of contextual offers into the OEM digital wallet (i.e. Google® Pay, Apple® Pay, Samsung® Pay, etc.) by selecting the ‘yes’ button 23. If the end-user opts-in for the auto-saving of offers, the media player automatically handles the requests to auto save offers to the end-user's digital wallet application, without requiring end-user interaction. The user can also select the ‘Always Auto-Save’ box 25 in which case the all ads which subsequently appear are auto-saved in the digital wallet without further action by the user. After the ad is saved, the video 15 immediately resumes playing. Unlike the prior art, by auto-saving the offer in the digital wallet, the user can return to the offer at any later time without further action by the user. Before the video 15 resumes, a brief alert 27 which may be in the nature of an overlay is shown notifying the user that the ad has been auto-saved, and can be viewed immediately if desired by selecting the alert 27. After the alert, unless the user decides to view the ad immediately, the video 15 resumes playing.

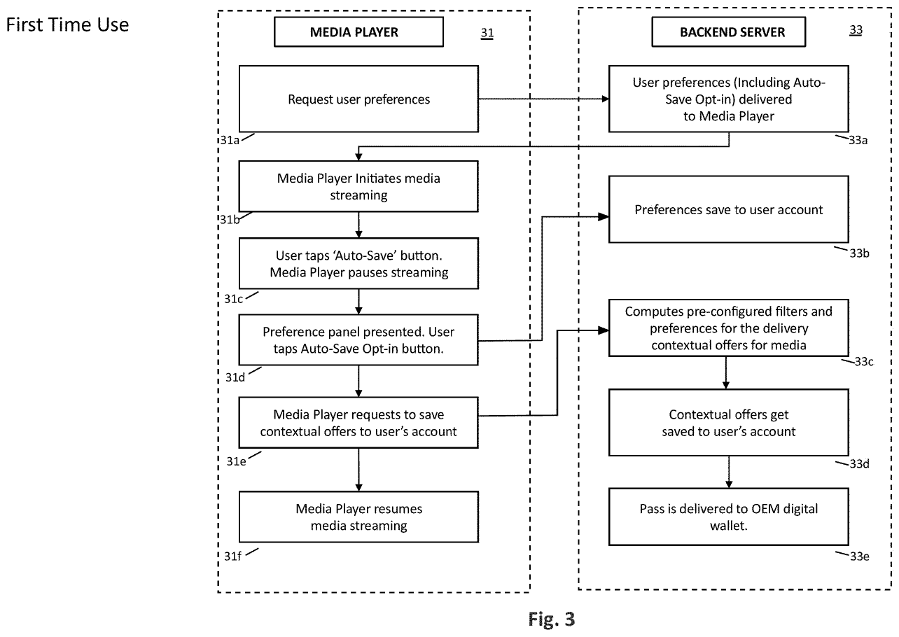

FIG. 3 is a diagram showing the workflow related to the Auto-Save button 21 (see FIG. 2) provided by the invention allowing users to save an offer to a digital wallet for later use, skip the ad and continue viewing the video

FIG. 3 illustrates a high-level process flow between a media player 31 on device 11 and a backend server 33 for a first time user or an end-user that has not yet enabled the “Auto-Save” feature. The media player makes a request 31a to the backend server 33 to retrieve the end-user's preferences. The backend provides 33a the stored end-user preferences. The media player initiates 31b media streaming. The media player displays the “Auto-Save” button which is a user interface (UI) element and pauses the streaming of content. Upon the end-user's tapping 31c on the “Auto-Save” button, a preference panel 31d (i.e. modal view) is presented for the end-user to opt-in for the Auto-Saving of contextual offers feature. The end-user's preference is stored 33b as part of the user's preferences in the backend server. If the end-user enabled the auto-saving of contextual offers, the media player automatically handles 31e the requests to save contextual offers as they are made available during the streaming of media content. The backend server computes 33c preconfigured filters and preferences for the delivery of contextual offers. Specifically, factors used by the backend server for use as filters and preferences include the specific time when the request is made, the IP address and geolocation information from where the request originates, the operating system and manufacturer of the device making the request, the device unique identifier and any additional metadata that can be used to define a user demographic segment, and finds the offers that best match the criteria. Then the backend server stores 33d such contextual offers into the end-user's account, and makes a server to server 33e request to the OEM digital wallet (e.g., Google® Pay, Apple® Pay, Samsung® Pay) backend system to store an electronic pass that contains all the protocols and necessary data (including logo, title, description, expiration date, redemption URL, redemption code, etc.) to render the offers in both a native OEM digital wallet application and/or its web based equivalent. These automatically saved electronic passes can be accessed at any time by the end-user. The media player resumes 31f media streaming.

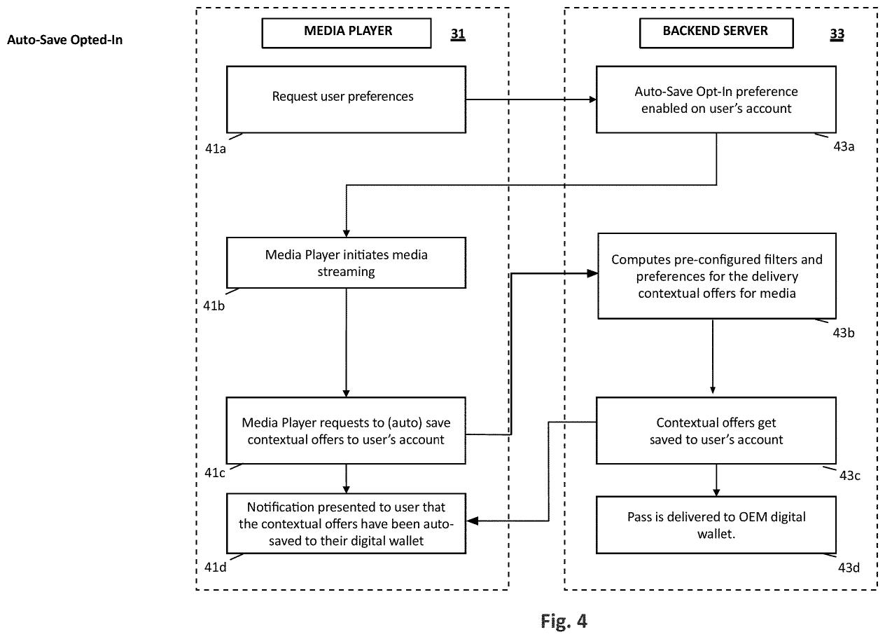

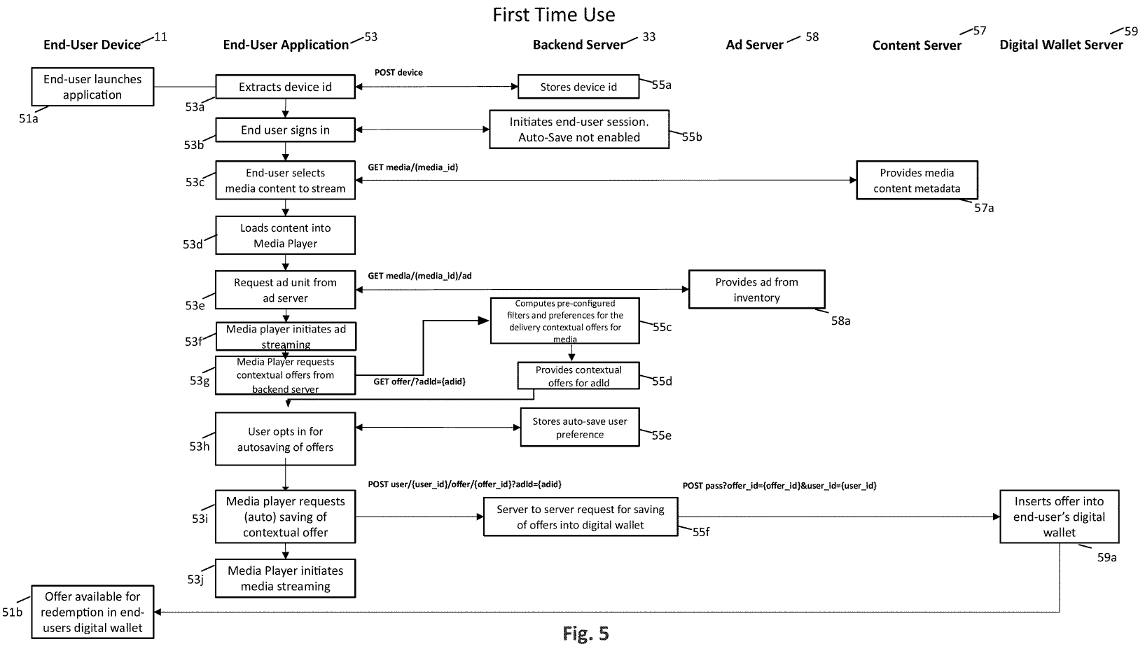

FIG. 4 illustrates a high-level process flow between the media player 31 and the backend server 33 for an end-user that has enabled for the “Auto-Save” feature. As shown in FIG. 4, the media player requests 41a the end-user preferences from the backend server. The end-user preferences include the “Auto-Save” feature the end-user has previously opted-in as described with reference to FIG. 3. The backend server provides 43a the stored auto-save opt-in user preference if enabled (see FIG. 2) on the user's account. The media player initiates 41b the streaming of media content, and makes requests 41c to the backend server to automatically save any contextual offers that match the user demographic. The backend server uses the specific time when the request is made, the IP address and geolocation information from where the request originates, the operating system and manufacturer of the device making the request, the device unique identifier and any additional metadata that can be used to define a user demographic segment, and finds the offers that best match the criteria. This does not require any interaction from the end-user. An important distinction from FIG. 3 is the fact that the media player does not pause the streaming of content when sending requests to auto save offers to backend server 33. The backend server saves 43c such contextual offers into the end-user's account, and delivers 43d an electronic pass that is pushed into the digital wallet backend systems as explained in more detail with reference to FIG. 5. A notification 41d is then presented to the end-user to inform the end user that contextual offers have been saved into their digital wallet. In an embodiment, the notification has one or more of the following characteristics.

FIG. 5 is a detailed description of the process flow between system components involved in the delivery of contextual offers using the “Auto-Save” feature. FIG. 5 is based on the “first-time user” condition, meaning, an end-user that has not enabled the contextual offer “Auto-Save” preference.

An end-user launches 51a an end-user application 53 on an end-user device 11 capable of streaming media (e.g., a mobile phone, tablet, smart TV, laptop, desktop, etc.). The end-user application extracts 53a the device id (unique identifier) from the device OS and sends a request to the backend server 33 to store it permanently. The end-user application provides a sign-in mechanism 53b for the end-user to log into his/her account. The authentication process is handled by the backend server, which initiates 55b an end-user session. The backend server retrieves the end-user preferences, including the Auto-Save option, which is disabled by default for first-time users. The end-user selects 53c the media content to stream from the end-user application. The content server 57 responds 57a with metadata about the media content (i.e. identifier, file location, ratings, etc.). Such metadata is used by the media player 31, which is a component of the end-user application 53, to load 53d the requested media content to stream. The media player 31 uses the media identifier media_id to request 53e an ad unit delivery from an ad server 58. The ad server response is an ad from inventory 58a which includes metadata related to the ad unit, including file location and ad identifier adId. The media player 31 uses this metadata to load the ad, and initiate 53f as streaming. The adId is used to request 53g contextual offers from the backend server 33 which computes 55c pre-configured filters and preferences as described above for the delivery of contextual offers. The specifics regarding ad server 58 and interactions with media player 31 and their implementations are well known in the art and need not be further described.

If contextual offers 55d are available, the media player prompts 53h the end-user to enable the auto-saving of offers. Upon end-user's selection, the media player sends a request 53i to the backend server 33 to store 55e the “Auto-Save” end-user preference. If the end-user enabled the auto-saving of offers, the media player automatically sends requests 55f to digital wallet server 59 on behalf of the end-user to save contextual offers as they are made available during the streaming of media content. The backend server handles the permanent storage of such contextual offers into the end-user's account, and also the generation of an electronic pass as described above that is pushed 59a into the digital wallet server 59 for later retrieval. Such electronic pass containing the offer is made available for redemption from the end-user's digital wallet application installed in the end-user's device. The operation implementations of such digital wallet applications and server are well known in the art.

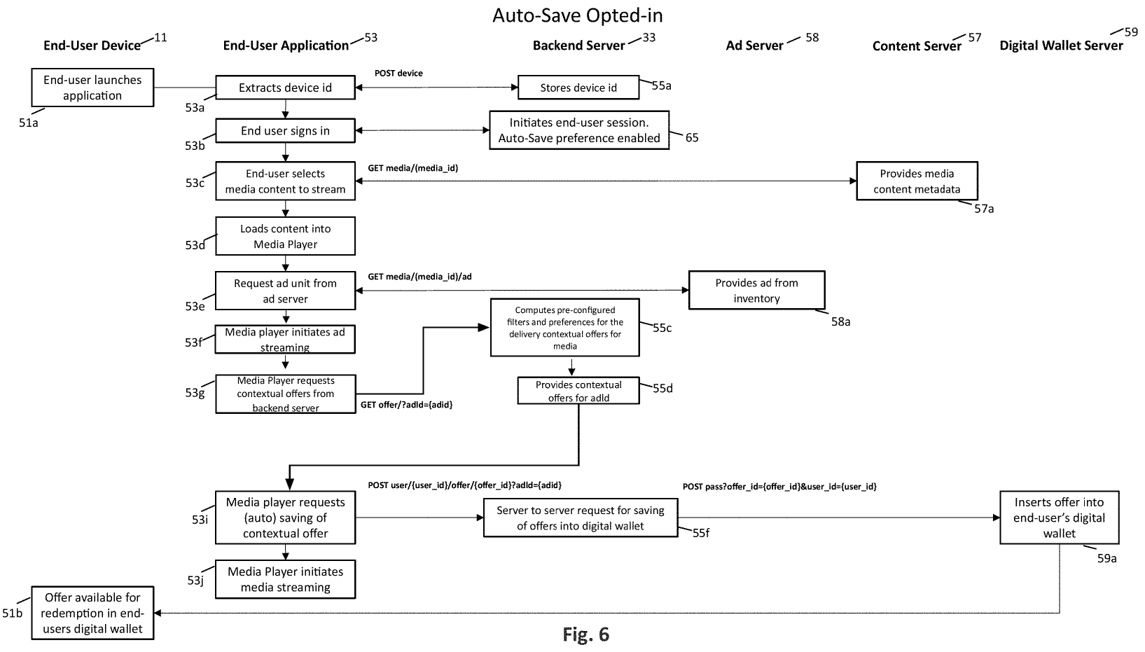

FIG. 6 is a detailed description of the process flow between system components involved in the delivery of contextual offers using the “Auto-Save” feature. This Figure is based on the “Auto-Save” enabled condition, meaning, an end-user that has enabled the contextual offer “Auto-Save” preference described with reference to FIG. 2.

An end-user launches 51a an end-user application 53 on an end-user device 11 capable of streaming media (i.e. mobile phone, tablet, smart TV, laptop, desktop, etc.). The end-user application extracts 53a the device id (unique identifier) from the device OS and sends a request to the backend server 33 to store it permanently. The end-user application provides a sign-in mechanism 53b for the end-user to log into his/her account. The authentication process is handled by the backend server, which initiates an end-user session. The backend server initiates the end-user session retrieves 65 the end-user preferences, including the Auto-Save option, which is enabled for end-users that have opted-in. The end-user selects 53c the media content to stream from the end-user application. The content server 57 responds with metadata about the media content (i.e. identifier, file location, ratings, etc.). Such metadata is used by the media player 31, which is a component of the end-user application, to load 53d the requested media content to stream. The media player uses the media identifier media_id to request 53e an ad unit delivery from an ad server 58. The ad server response 58a includes metadata related to the ad unit, including file location and ad identifier adId. The media player uses this metadata to load the ad and initiate 55f ad streaming, and the adId is used to request 53g contextual offers from the backend server which computes 55c pre-configured filters and preferences for the delivery of contextual offers as described above. Since the end-user has previously enabled the auto-saving of contextual offers, the media player automatically sends requests 53i on behalf of the end-user to save contextual offers as they are made available during the streaming of media content. The backend server handles the permanent storage of such contextual offers into the end-user's account, and also the generation of an electronic pass that is pushed 55f into the digital wallet server 59 which operates to insert 59a the offer into the end user's digital wallet for later retrieval. Such digital pass containing the offer is made available for redemption 51b from the end-user's digital wallet application installed in the end-user's device.

The invention may be implemented in alternative ways. Embodiments of the invention may locate components in different locations that may be together within a single location or scattered across various locations, and they may consolidate multiple components within a single component that performs the same functions as the consolidated components.

An embodiment of the invention may be a machine-readable medium having stored thereon instructions which cause a processor to perform operations as described above. In other embodiments the operations might be performed by specific hardware components that contain hardwired logic. Those operations might alternatively be performed by any combination of programmed computer components and custom hardware components.

A machine-readable medium may include any mechanism for storing or transmitting information in a form readable by any type of processing device.

Although specific examples of how the invention may be implemented are described, the invention is not limited by the specified examples, and is limited only by the scope of the following claims.

1. A method for enabling advertising or promotional information presented during content being played to be saved for later access comprising:
receiving a video or audio link from an external source for playing a video or audio on a display device, said display device including a display screen, processor and communications components to enable said display device to communicate via a media network;
during said playing, receiving an initial offer from a second external source, pausing said playing and displaying said initial offer on said display device;
while displaying said initial offer, presenting an option on said to display device to auto-save said initial offer, wherein selecting said auto-save option saves said offer to a wallet app running on said display device, and presenting a second option on said display device to enable subsequent received offers from said second external source to be auto-saved to said wallet app.

2. The method defined by claim 1 wherein said initial offers and said subsequent received offers are based on filters and preferences which define criteria for selecting said initial offers and subsequent received offers for said saving and auto-saving to said wallet app.

3. The method defined by claim 2 wherein a backend server computes said filters and preferences using factors which include at least one of a specific time when a request is made by said display device for preferences associated with a user of said display device, an IP address and geolocation information from where the request originates, an operating system and manufacturer of the display device making the request, the display device unique identifier and any additional metadata that to define the user's demographic information, and finds offers that best match the criteria.

4. The method defined by claim 1, wherein after said offer is saved or auto-saved, resuming said playing.

5. The method defined by claim 1 wherein said offer is related to said content being played.

6. The method defined by claim 1 wherein said presented option includes an active button which when selected causes an overlay to be displayed on said playback device, said overlay containing further details for said initial offer and a second active button which corresponds to said second option.

7. The method defined by claim 1 wherein said display device includes an API client, and a media player and said communications components enable said display device to communicates with a backend server and a video ad server over a network.

8. The method defined by claim 7 wherein said backend server operates to identify and return content from said video ad server for presenting as the initial offer and the subsequent offers to the display device.

9. The method defined by claim 6 wherein said overlay further comprises a view now button which when pressed presents on the display device further information relevant to said initial offer.

10. A method for enabling advertising or promotional information presented during content being played to be saved for later access comprising:
receiving a video or audio link from an external source for playing a video or audio on a display device, said display device including a display screen, processor and communications components to enable said display device to communicate via a media network;
during said playing, receiving an offer from a second external source;
auto-saving said offer to a wallet app.

11. The method defined by claim 10 wherein said offer is based on filters and preferences which define criteria for selecting said offer and subsequent offers for and auto-saving to said wallet app.

12. The method defined by claim 11 wherein a backend server computes said filters and preferences using factors which include at least one of a specific time when a request is made by said display device for preferences associated with a user of said display device, an IP address and geolocation information from where the request originates, an operating system and manufacturer of the display device making the request, the display device unique identifier and any additional metadata that to define the user's demographic information, and finds offers that best match the criteria.

13. The method defined by claim 10, wherein after said offer is auto-saved, resuming said playing.

14. The method defined by claim 10 wherein said offer is related to said content being played.

15. The method defined by claim 10 wherein said auto-saving causes an overlay to be displayed on said playback device, said overlay including a message that said offer has been auto-saved to said wallet app.

16. The method defined by claim 10 wherein said display device includes an API client, and a media player and said communications components enable said display device to communicates with a backend server and a video ad server over a network.

17. The method defined by claim 16 wherein said backend server operates to identify and return content from said video ad server for presenting as the offer to the display device.

18. The method defined by claim 15 wherein said overlay further comprises a view now button which when pressed presents on the display device further information relevant to said offer.
